(19) United States
(12) Patent Application Publication
(10) Pub. No.: US 2008/0072446 A1
(43) Pub. Date: Mar. 27, 2008

(54) Tape measure having digital output

(76) Inventor: A Te Hu, Taipei Hsien (TW)

Correspondence Address: CHARLES E. BAXLEY, ESQ., 90 JOHN STREET, THIRD FLOOR, NEW YORK, NY, 10038, US

(21) Appl. No.: 11/528,066

(22) Filed: Sep. 26, 2006

(51) Int. Cl. G01B 3/10

(52) U.S. Cl. 33/762

(57) ABSTRACT

A tape measure includes a measuring tape for measuring purposes, a detecting device coupled to the measuring tape for measuring a moving distance of the measuring tape relative to the detecting device, a processing device coupled to the detecting device for calculating a value detected by the detecting device into a digital output, a displayer coupled to the processing device for displaying the digital output corresponding to the moving distance of the measuring tape relative to the detecting device, and a driver device coupled to the displayer for actuating the displayer to display the digital output and for allowing the work pieces or objects to be easily and quickly measured by the users.

### BACKGROUND OF THE INVENTION

1. Field of the Invention

The present invention relates to a tape measure, and more particularly to a tape measure including a digital output for precisely converting and showing the detected distance into a digital value and for allowing the user to easily and quickly measure the work pieces or objects to be measured.

2. Description of the Prior Art

Typical tape measures comprise a measuring tape made of such as a metal strip and having suitable indicia on one or both sides of its surface and having a transverse curvature for giving the measuring tape a tendency to expand outwardly and to hold a straight line position when drawn outwardly from its casing.

For example, U.S. Pat. No. 5,040,256 to Mills, and U.S. Pat. No. 5,119,521 to Clontz disclose two of the typical tape measures each also comprising a measuring tape received as a coil within an outer housing or casing and movable out of the outer housing or casing for tape measuring purposes.

U.S. Pat. No. 5,802,732 to Malone discloses another typical tape measure also comprising a measuring tape received as a coil within an outer housing or casing and movable out of the outer housing or casing by the users or workers for tape measuring purposes.

However, while measuring, the users have to closely align the measuring tape with the work pieces or objects to be measured and to read the indicia corresponding to the work pieces or objects to be measured. It will be difficult for the user to precisely read and take the measurement from the indicia provided on the measuring tape.

The present invention has arisen to mitigate and/or obviate the afore-described disadvantages of the conventional tape measures.

### SUMMARY OF THE INVENTION

The primary objective of the present invention is to provide a tape measure including a digital output for precisely converting and showing the detected distance into a digital value and for allowing the user to easily and quickly measure the work pieces or objects to be measured.

In accordance with one aspect of the invention, there is provided a tape measure comprising a measuring tape for measuring purposes, a detecting device coupled to the measuring tape for measuring a moving distance of the measuring tape relative to the detecting device, a processing device coupled to the detecting device for calculating a value detected by the detecting device into a digital output, a displayer coupled to the processing device for displaying the digital output corresponding to the moving distance of the measuring tape relative to the detecting device, a driver device coupled to the displayer for actuating the displayer to display the digital output, and a power supply coupled to the processing device and the displayer for energizing the processing device and the displayer.

The measuring tape includes a metric indicia and/or a British indicia provided thereon. A housing may further be provided for receiving the measuring tape and the detecting device and the driver device and the power supply. The housing includes a key ring attached thereto for forming a key ring device.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a tape measure in accordance with the present invention;

FIG. 2 is a block diagram illustrating the parts or elements of the tape measure;

FIG. 3 is a plan schematic view illustrating the other arrangement of the tape measure;

FIG. 4 is a partial plan schematic view illustrating the further arrangement of the tape measure; and

FIG. 5 is a perspective view illustrating the still further arrangement of the tape measure.

### DETAILED DESCRIPTION OF THE PREFERRED EMBODIMENT

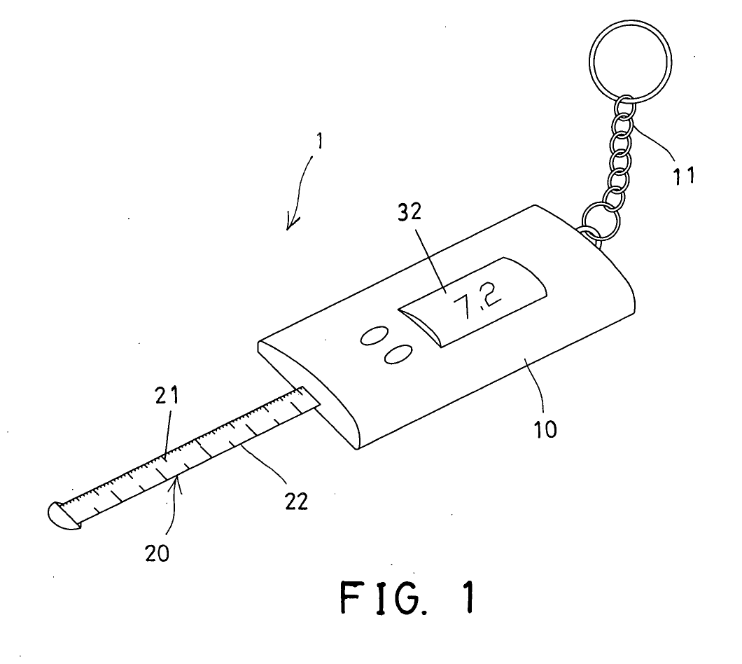

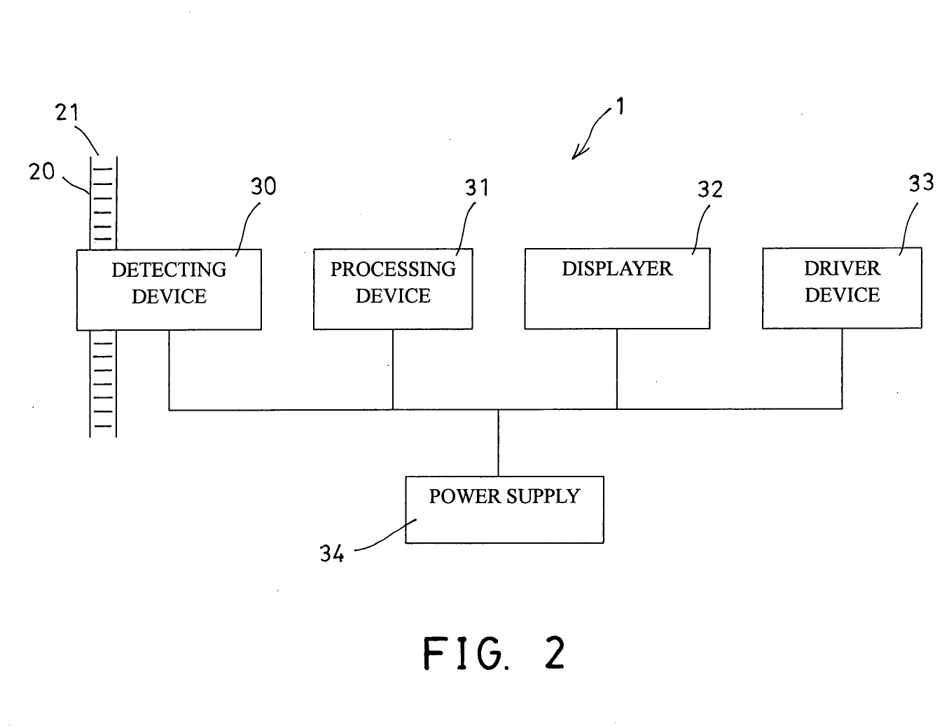

Referring to the drawings, and initially to FIGS. 1 and 2, a tape measure 1 in accordance with the present invention comprises an outer casing or housing 10, and a measuring tape 20 to be received as a coil within the housing 10 and to be pulled and moved out of the outer housing 10 by the users or workers for tape measuring purposes. The measuring tape 20 may include a metric indicia or graduation 21 and/or a British indicia or graduation 22 provided on either or both sides of its surface. The above-described structure of the tape measure 1 is typical and will not be described in further details.

As shown in FIG. 2, the tape measure 1 further includes a detecting device 30 disposed in the housing 10 and coupled to the measuring tape 20 for detecting or measuring the movement or the moving distance of the measuring tape 20 relative to the housing 10 and/or the detecting device 30. The detecting device 30 may be selected from an infrared detecting device 30, a photo-sensitive detecting device 30, a mechanical or gearing detecting device 30, or the like. A counter or calculator or processing device 31 also disposed in the housing 10 and coupled to the detecting device 30 for calculating or converting the value detected or measured by the detecting device 30 into a digital output.

A displayer 32, such as a liquid crystal displayer 32 may also be disposed in the housing 10 and coupled to the processing device 31 for showing or displaying or illustrating the digital output that corresponds to the movement or the moving distance of the measuring tape 20 relative to the housing 10 and/or the detecting device 30. A driver device 33 may also be disposed in the housing 10 and coupled to the displayer 32 for driving or operating or actuating the displayer 32 to display the digital output. A power supply 34, such as a 3V or 1.5V DC battery 34 may also be disposed in the housing 10 and coupled to the detecting device 30 and/or the processing device 31 and/or the displayer 32 and/or the driver device 33 or other electric parts or elements for energizing the electric parts or elements.

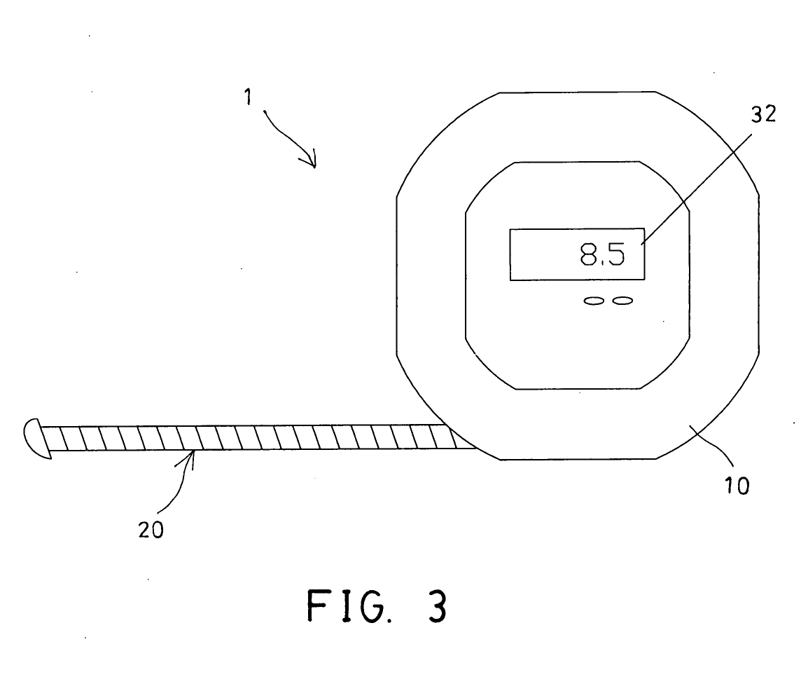

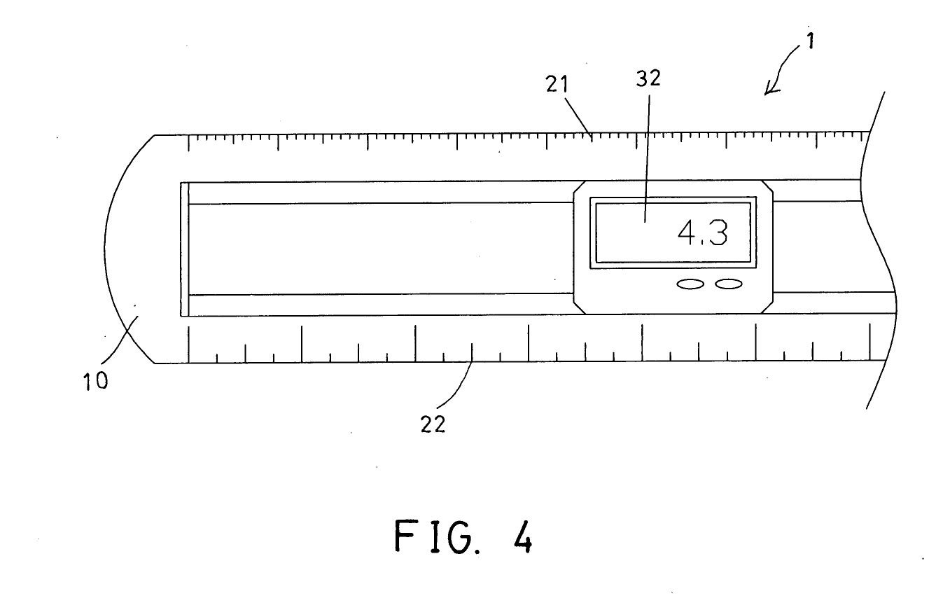

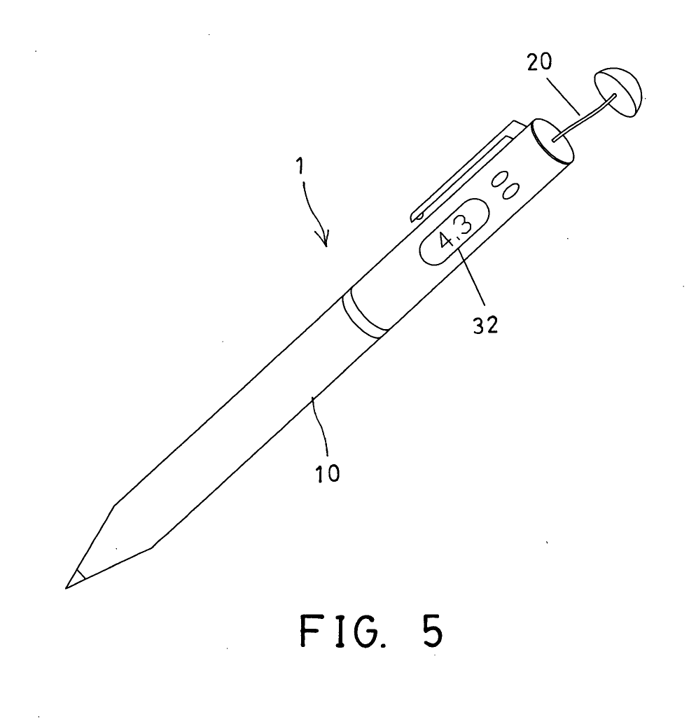

In operation, as shown in FIG. 1, the housing 10 may include a key ring 11 attached thereto for forming or acting as a key ring device. Alternatively, as shown in FIG. 3, the detecting device 30 and/or the processing device 31 and/or the displayer 32 and/or the driver device 33 (FIG. 2) may also be disposed in the housing 10 of the tape measure for easily and quickly measuring the work pieces or objects to be measured. As shown in FIG. 4, the detecting device 30 and/or the processing device 31 and/or the displayer 32 and/or the driver device 33 (FIG. 2) may also be disposed in the rule housing 10, or may be disposed in the pen as shown in FIG. 5, in which the measuring tape 20 may be replaced by a rope or cable-type measuring tape 20.

The housing 10 of the tape measure 1 in accordance with the present invention comprises a greatly or relative reduced size or volume for allowing the tape measure 1 to be easily carried with the users and to be easily operated by the users to quickly measure the work pieces or objects to be measured.

Accordingly, the tape measure in accordance with the present invention includes a digital output for precisely converting and showing the detected distance into a digital value and for allowing the user to easily and quickly measure the work pieces or objects to be measured.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A tape measure comprising:
a measuring tape for measuring purposes,
a detecting device coupled to said measuring tape for measuring a moving distance of said measuring tape relative to said detecting device,
a processing device coupled to said detecting device for calculating a value detected by said detecting device into a digital output,
a displayer coupled to said processing device for displaying said digital output corresponding to said moving distance of said measuring tape relative to said detecting device,
a driver device coupled to said displayer for actuating said displayer to display said digital output, and
a power supply coupled to said processing device and said displayer for energizing said processing device and said displayer.

2. The tape measure as claimed in claim 1, wherein said measuring tape includes a metric indicia provided thereon.

3. The tape measure as claimed in claim 1, wherein said measuring tape includes a British indicia provided thereon.

4. The tape measure as claimed in claim 1 further comprising a housing for receiving said measuring tape and said detecting device and said driver device and said power supply.

5. The tape measure as claimed in claim 4, wherein said housing includes a key ring attached thereto for forming a key ring device.
